(19) United States
(12) Patent Application Publication
(10) Pub. No.: US 2007/0081175 A1
(43) Pub. Date: Apr. 12, 2007

(54) Hollow dot printing apparatus and methods

(75) Inventor: William Grier, Highland, CA (US)

Correspondence Address: Hani Z. Sayed, Esq.;c/o Rutan & Tucker, LLP, 611 ANTON BLVD, SUITE 1400, COSTA MESA, CA, 92626, US

(73) Assignee: Colorep, Inc.

(21) Appl. No.: 11/543,449

(22) Filed: Oct. 4, 2006

Related U.S. Application Data
(60) Provisional application No. 60/724,408, filed on Oct. 7, 2005.

(51) Int. Cl. G06K 15/12

(52) U.S. Cl. 358/1.7; 358/502

(57) ABSTRACT

A printing device in which dots are made to implode, rather than explode when transformed into dye-laden gas. Each of the plurality of dots having a smaller cross-section on the object than on the source and each have a concave silhouette. The plurality of dots also have a ring-shaped surface prior to transfer to a source, such as a transfer paper. In preferred embodiments this is accomplished by converting the dot profile to a concave silhouette or a hollow dot, which implodes upon itself when transformed into gas state by heat. It is further contemplated that the device, such as an ink jet printer or an electrostatic printer to transfer the dots to a fabric. Preferably, the fabric is a clothing fabric, but can also include a wall paper fabric, and even carpet, paper, plastic, and powder coated metal.

This application claims priority to U.S. provisional application Ser. No. 60/724,408 filed Oct. 7, 2005.

### FIELD OF THE INVENTION

The field of the invention is dyeing and printing of material.

### BACKGROUND

Imagine Michelangelo using just one brush to paint the ceiling of the Sistine Chapel. He would spend half of his time just on changing paint and cleaning the brush. It would be much easier if he could paint the ceiling portrait by using a special brush that applies all the colors with each stroke. This precisely happens every day in the printing world, including printing in magazines, in books, on billboards, on desktop printers, in television, and on advertising materials. For efficient printing, the color photographs in magazines, such as Time™ magazine, requires each color to be printed separately and the press to be disassembled and cleaned after each pass. The only way to print for such magazines is to reduce each picture to “paint by the numbers” spaces then put only those six or eight colors on the press. This creates a problem in the amount of preparation work and post-printing clean up that is involved. Magazines have to print tens of thousands of copies to break even on the printing costs. Thus, all the print and publishing companies learned long ago how to produce multicolored images in one process.

Process printing was developed as a solution for printing many copies on substantially all hard flat surfaces, including glossy magazines, posters and the like in one process. During process printing, a full or multicolor original is reproduced through the use of several (usually between two and four) halftone plates. The colors involved are cyan, magenta, yellow, and black, which are known as CMYK process colors. Process printing has been successful in the print and publication industriay by providing a variety of vibrant and vivid colors. Unfortunately, process printing is not readily applicable for printing on fabrics. For printing on fabric, it is technically challenging and commercially unviable to place process color dots in exact positions on a moving piece of stretching cloth. It often requires too much time and efforts to complete the printing for a satisfactory product.

One solution is to use conventional sublimation technology. In that process, all of the process colors are all printed at the same time in one pass on a donor paper, and the image is then transferred from the donor paper to the target fabric using heat and pressure. While sublimation printing can work reasonably well for some images and some fabrics, the process is quite difficult to employ because different types of fabrics, and even different pieces or constructions of the same fabric, react inconsistently to the various dyes and inks.

In addition, sublimation printing on fabrics is limited to relatively low resolutions because the colored dots tend to expand into one another. For example, one might specify a 10 percent dot, but the final printed piece the resulting dot is actually 15 or 20% larger. The increase in the measured tint value during prepress, plate making, printing and transfer is known as dot gain. In other words, when a paper absorbs fountain pen ink, the ink spreads from whatever lines are drawn. Depending on the absorbency of the paper, the ink may spread a little or a lot, which is known as dot gain.

Dot gain occurs at each place where ink is put on paper and the ink spreads. When the ink spreads, the resulting dot size is larger than the specified dot size. A 15% dot may end up looking like a 17% dot. While this change may be insignificant by itself, when four layers of a color separation are combined in one print, dot gain can substantially change the color of the image, usually degrading the image quality. When factors in the additional step of turning the dots to dye laden gas and propelling then into a fabric receiver, the dot gain becomes almost uncontrollable.

Although simple to understand, dot gain is an extremely difficult problem to address. Among other things, variations in the amount of dot gain in sublimation printing occur in many stages, and for a variety of reasons, including differences in donor papers, inks and final substrates. Standard printing technology has developed compensation curves and techniques for dealing with relatively small dot gain, such as 20%, but even such percentage, common in sublimation (gas transfer printing) is just too great for conventional technology to deal with.

In sublimation printing the massive dot gain that occurs during the gas transfer of dye from the donor paper to the receiving fabric causes the dots to overlap at about 50% saturation, and therefore negate the available colors produced by process color printing. Dot gain makes images look darker than they should, and when printing in process color, can cause unwanted color shifts and loss of subtlety in photographic prints. Dot gain in standard four color process sublimation reduces the colors available to less than a commercially viable palette.

Another solution to compensate for dot gain is to print using smaller dots on any given fabric as shown in U.S. Pat. No. 7,073,902 to Codos et al. (Jul. 11, 2006). However, this solution also fails because the more dots that are printed, usually for high resolution printing, the greater the percentage of dot gain.

Thus, there is still a need for providing apparatus and methods that reduce dot gain, and thereby allow for, among other things, high definition sublimation printing on a variety of fabrics.

This and all other referenced extrinsic materials are incorporated herein by reference in their entirety. Where a definition or use of a term in an incorporated reference is inconsistent or contrary to the definition of that term provided herein, the definition of that term provided herein applies and the definition of that term in the reference does not apply.

### SUMMARY OF THE INVENTION

The present invention provides systems and methods in which dots are made to implode, rather than explode when transformed into dye-laden gas. In preferred embodiments this is accomplished by converting the dot profile to a concave silhouette or a hollow dot, which implodes upon itself when transformed into gas state by heat.

In preferred embodiments of the present inventive subject matter, a device is provided that prints an image by transferring a plurality of dots from a source to a target. Each of the plurality of dots has a smaller cross-section on the object than on the source and each has a concave silhouette. The plurality of dots also have a ring-shaped surface prior to transfer to a source, such as a transfer paper.

Among the many different possibilities contemplated, each device comprises the use of an ink jet printer or an electrostatic printer to accomplish the transfer of the dots. It is also contemplated that an offset press or a rotogravure press can transfer the dots as well.

It is further contemplated that the device transfer the dots to a fabric. Preferably, the fabric is a clothing fabric, but can also include a wall paper fabric, and even carpet, paper, plastic, and powder coated metal.

Preferably, the dots are transferred in a gaseous form and at least some of the dots are colored. It can be advantageous where there are four different ones of the dots that have different color from one another.

Further embodiments preferred a device that prints an image by transferring the dots from a source to a target, where all the dots are either concave on one surface or possibly bi-concave on both surfaces or opposing concavities.

It is further preferred a method to printing an image on a target by creating a dot representation of the image, then producing physical dots corresponding to the dot representation, and transferring the physical dots to the target. Among all the contemplated possibilities, it is preferred that the dot representation is presented in a digital format. To sufficiently transfer the physical dots to the target, sufficient heat or likely sources must vaporize the physical dots. It is also contemplated that the dots can be transferred to a moving fabric.

It should, of course, be apparent to those skilled in the art that many more modifications besides those already described are possible without departing from the inventive concepts herein. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps could be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWING

FIG. 1 is a schematic of processing equipment according to the teachings herein.

FIG. 2 is a schematic drawing of the donor material having hollow dots.

FIG. 3 is a sketch view of a hollow dot.

FIG. 4 is a sketch view of a traditional standard dot.

FIG. 5 is a cross section view of a hollow dot.

FIG. 6 is a cross section view of a traditional standard dot.

FIG. 7 is a schematic view of the hollow dot printing during heating.

FIG. 8 is a schematic view of the traditional standard dot printing during heating.

### DETAILED DESCRIPTION

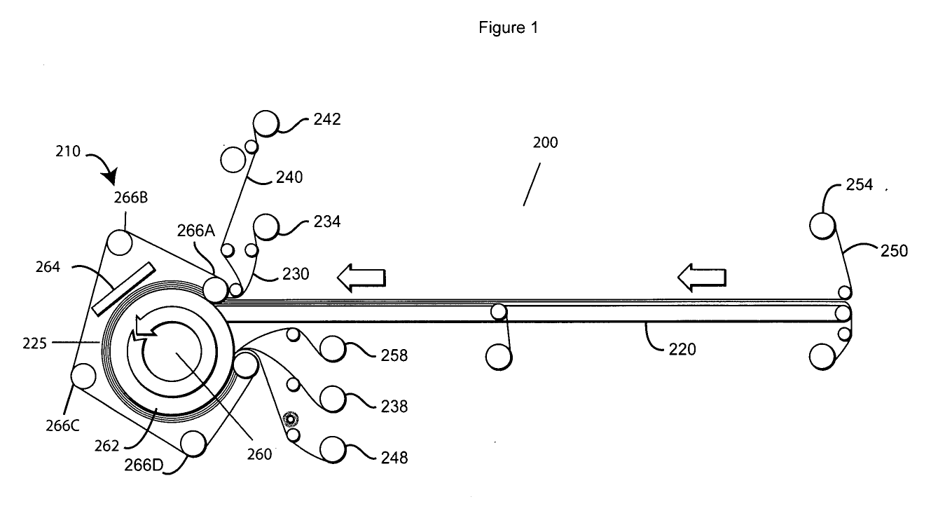

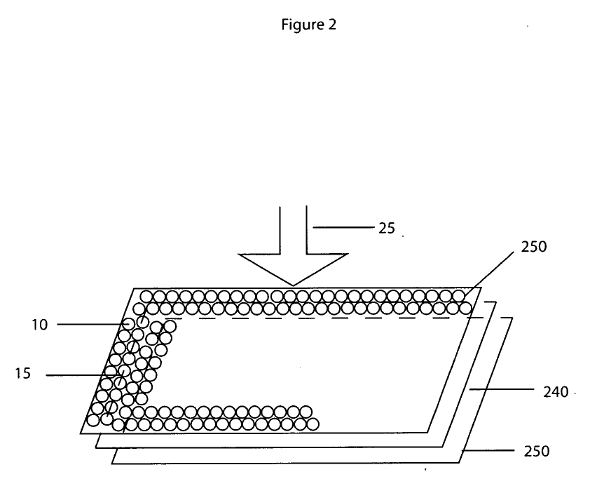

In FIG. 1, a process equipment 200 generally includes a heating portion 210 and a work table 220. Positioned on the machine is a continuous work piece 225 (also shown in FIG. 2) comprising: a donor material 230 with corresponding a donor feed roll 234 and the donor take up roll 238; a tissue 240 with corresponding tissue feed roll 242 and tissue 240 take up roll 248; and a receiver 250 with corresponding receiver feed roll 254 and receiver take up roll 258.

The donor material 230 can be selected from known donor papers, or other materials used in the industry. The donor material can be any thin sheet that is substantially impassible to dye from side to side, but which has a surface to which a dye can be temporarily held. It should also be appreciated that the terms “dye” and “dyes” are used in the broadest possible sense to include inks, and indeed any chemical composition that can be transferred to a receiving material to color that material. Thus, the terms “dye” and “dyes” include chemical compositions that can change color depending upon temperature or other conditions, and even chemical compositions that are colorless when applied, but turn color upon exposure to moisture, or high temperature.

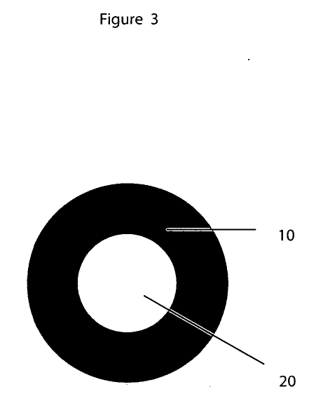

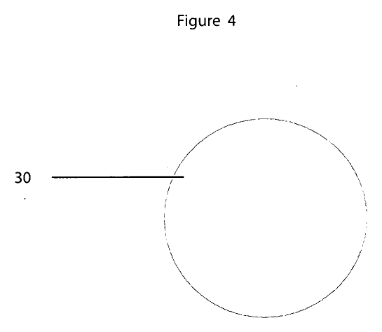

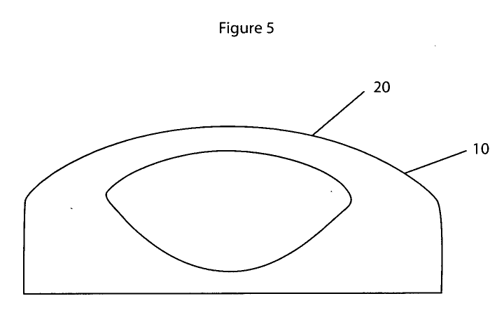

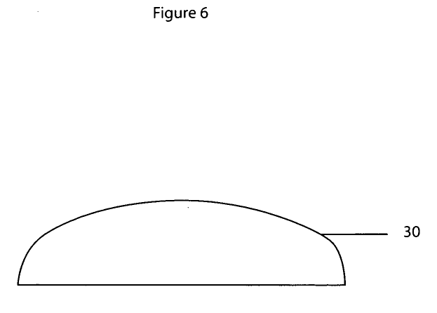

Preferably, the donor material 230 comprises a plurality of hollow dots 10 that contains dyes 15 as shown in FIG. 2. The physical characteristics of the hollow dot 10 are shown in FIG. 3 and FIG. 5. The hollow dot has a ring-shaped surface that gives a concave silhouette. Instead of a conventional dot as shown in FIG. 4 and FIG. 6, where the dot is in a solid form and middle portion is round and full, hollow dot 10 is concave and hollow. It is also contemplated that the dots have a concave silhouette on both sides of the dots, as a bi-hollow dot. Other shapes where the dot is concave are also contemplated. Preferably, a dot on the donor is no larger than 1/400^{th} of an inch or 400 dpi and a dot on the receiver is no larger than 1/350^{th} of an inch or 350 dpi. It is contemplated that the cross section of the dots will present a smaller cross section once the dots are transferred from the donor materials 230 to receiver then to the tissue.

The dyes on the donor material 230 then goes through a heating portion 260 for sublimation. The heating portion 260 generally includes a rotary primary heating element 262, a fixed heating element 264, and a heat conductive web 266. The rotation speed, configuration and dimensions of the heating portion 260 determine the dwell time of sublimating heat upon the sandwiched work piece of donor materials 230, receiver 240 and tissue 260. Thus, it is contemplated that heat sufficient to sublimate would be applied from at least one side of the receiver for at least 5 seconds, more preferably at least 10 seconds, 20 seconds, 40 seconds, 60 seconds, and most preferably at 80 seconds. However, it is contemplated that any heating from 5 seconds to 3 minutes is the anticipated acceptable range. Sublimation temperature is preferably no more than 400° F. (204.4° C.), and more preferably less.

Heating by forced hot air is preferred, although other heat sources, such as infrared heaters, can be used as long as they adequately penetrate the fabric to the depth of the ink. In addition to heat, other mechanisms can be used for setting the dye, which can be determined from those mechanisms commonly used with particular dyes and substrate combinations.

Despite a current preference for continuous processing, it is also contemplated that embodiments of the inventive subject matter could be practiced in a discontinuous manner, for example with sandwiched work pieces being assembled, and heat and pressure applied in a piece by piece manner. In that regard it is specifically contemplated that the receiver could be cut from a bulk material. There are existing machines (e.g. Monti Antonio™, Practix™ and other cylinder based machines) that could be modified to operate according the inventive concepts described herein.

In preferred embodiments, upon heating, the hollow dots containing dyes will have either reacted or formed an affinity with certain fiber surfaces. With dye-based formulation, the heating step of the process causes the dye particles to change from a solid state to a gas state. In a gas state, the dye particles can enter into a tissue, such as polyester fabric fibers, and to set the dye. The heat opens pores in the polyester fiber allowing the gas to enter. It also is believed to cause the particles of dye to enter a molecular form which is more highly reflective and capable of producing more brilliant color on the substrate. Once the material cools, the dye particles are trapped internally in the polyester fiber, possibly reverting back to their solid state or at least being fixed in the solid substrate fibers. So when white fabric is placed against printed donor paper and heat is applied to the paper exciting the molecules to a gas state. As heated dye molecules the now heated fabric, they exchange places and become part of the fabric filament. Now the dye laden molecules are a permanent part of the interior of the fabric and are not affected by normal washing or bleaching.

The hollow dots 10 consists of concentrated ink and can be of any color, but preferably in the CMYK color palette. It is contemplated that conventional ink jets can be used to jet ink from the dots at conventional rate or preferably at 75 picoliters, or approximately 80 nanograms, per drop, and to do so for each of four colors in the CMYK color palette. Upon heating from a heat source 25 as shown in FIG. 2, the hollow dots 10 will implode the color ink from donor material 230 to receiver 240 then to tissue 250. Unlike conventional dots, the shape of the hollow dots does not explode, but rather implode, thereby directing the ink within to a smaller surface area than would the conventional dots. Due to their concave silhouette, the dot gain of the hollow dots are reduced from 20% dot gain effect to as small as 2% dot gain effect. Instead of printing standard dot in which the dyes filled the dot, it is preferred in the present inventive subject matter, to print a hollow or concave dot in which only small portion of the dye is contained in the hollow dot. This can be accomplished by printing on an outside edge of the hollow dot onto a donor material.

The advantages of the methods and systems disclosed herein are enormous. For the first time, a designer can obtain complex color prints on fabric without the unwanted dot gain effect and thus producing almost perfect color consistency, in a commercially viable manner. Thus, a t-shirt designer can generate multi-color t-shirts without worrying about limiting the number of colors used or the bleeding effect of using multiple colors. Similarly, a carpet designer can play with an array of colors in designing a carpet with multicolor hues and depths. Those skilled in the art will appreciate that the inventive subject matter can be applied to any material that warrants color prints, including clothes, handbags and other accessories, furniture, fabrics to cover non-furniture spaces in automobiles and other motor vehicles carpets, powder coated metals, plastics and so forth.

Printing complex patterns and even photographic or other images can also be possible, with third, fourth, and other colors since the dot gain has been greatly reduced and the colors will not bleed into each other. Indeed, to simplify the drawing, FIG. 1 should be interpreted generically as including all such combinations.

The tissue 240 can be selected from known take up tissues used in the industry and is used in the current embodiments to absorb dyes that pass entirely through the receiver 250 and donor material 230. It also serves in embodiments of the present invention to protect the mechanical parts from excess colorant.

The receiver 250 can be any material that can receive sublimation printing. This includes most especially polyesters and other synthetic polymers that absorb dyes at high temperature and pressure, with currently preferred receiver materials including the true synthetics or non-cellulosics (e.g., polyester, nylon, acrylic, modacrylic, and polyolefin), blends, and so forth. It is contemplated that receiver materials could also include natural fibers (e.g., cotton, wool, silk, linen, hemp, ramie, and jute), semi-synthetics or cellulosics (e.g., vicose rayon and cellulose acetate), but currently available colorants do not “take” very well with such fibers. Receivers can be flexible or rigid, bleached or unbleached, white or colored, woven, non-woven, knitted or non-knitted, or any combination of these or other factors. Thus, a receiver could, for example, include a woven material on one side and a non-woven or different woven material on the other side. Among other things, receivers are contemplated to include fabrics and fibers used for clothing, banners, flags, curtains and other wall coverings, and even carpets.

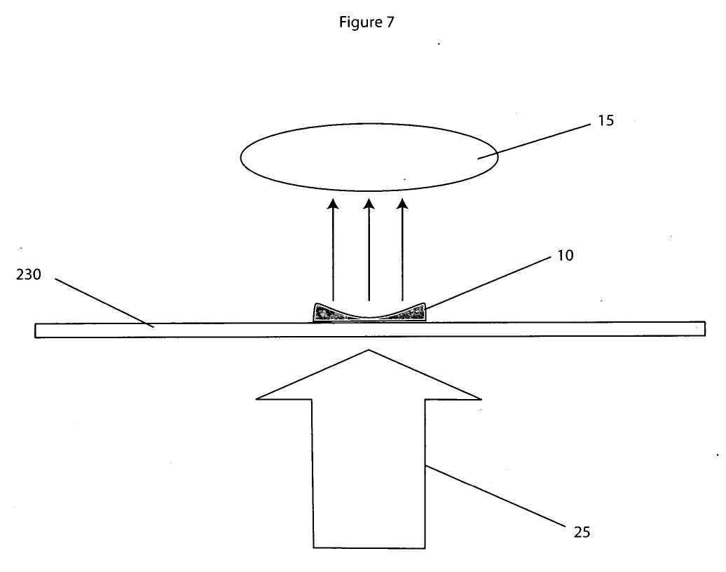

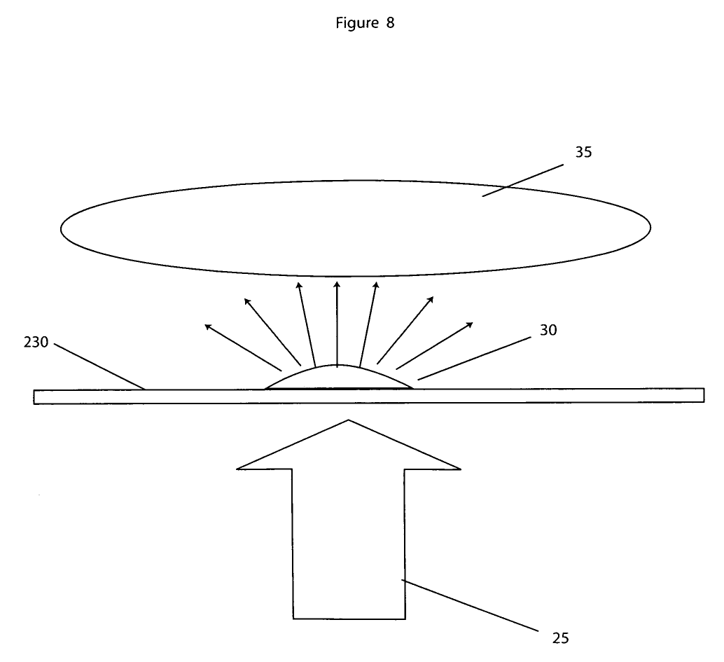

In FIG. 7, a heat source 25 changes the hollow dot 10 of the donor material 230 from a solid state to a gaseous state. Instead exploding the gas-laden dye, the concave silhouette implodes upon the heat and thus creates a much smaller dot gain effect 15 and thereby The traditional dot printing as shown in FIG. 8 illustrates that upon heating, the standard dot 30 of the donor material 230 explodes in all directions and thus creates a far greater dot gain effect 35.

When rolled into the heating portion, the dyes of the conventional dots will explode and cause dot gain to radiate throughout the receiver as shown in FIG. 2. Hollow dots, on the other hand, reserves the dots in its concave silhouette and when heated, the dyes transform into a gaseous state and implode to the receiver. This is advantageous because it allows for a more direct application of the dye without the excess dot gain effect. It is contemplated that the hollow dots can have a different color from one another. It is also contemplated that the dots can be bi-concave and limited concaveness to obtain different levels of dye effect on a receiver. Multiple color dyes can be rolled and released at the same time to the receiver and yet the dot gain will be small.

Preferably, a representation of the image is first created on the donor material, and then physical hollow dots are created to correspond to the image representation. Then the hollow dots carrying the dyes of the image is transferred to a receiver upon receiving sufficient heat and vaporizing the dots to the receiver. Among all the contemplated possibilities, it is preferred that the dot representation is presented in a digital format. However, other formats are entertained with the present inventive subject matter. It is also contemplated that the dots can be transferred to a moving fabric.

### EXAMPLES

The following examples illustrate particularly embodiments of the present inventive subject matter, and aid those of skill in the art in understanding and practicing the inventive subject matter. They are set forth for explanatory purposes only, and are not to be taken as limiting the present inventive subject matter in any manner.

### Example 1

### Color Shift Caused by Dot Gain

One embodiment of the present inventive subject matter is the use of hollow dot printing. Customer requested color based off the CMYB palette listed as the Input Value in Table 1, to be printed on fabric. Traditional method of the four color CMYB process was used with normal printing and transfer dot gain. The output value of the traditional method in general saw a significant increase of dot gain effect. The average dot gain increase for the traditional method is 12.75%, a value taken based upon the sum of the Traditional Dot Gain divided by four of the four colors. In contrast, hollow dot printing produces far less dot gain increase as shown in Hollow Dot Output Value. The average dot gain for hollow dot printing is 3.25%.

TABLE 1

| | | | | Hollow | |
|---|---|---|---|---|---|
| | | Traditional | Traditional Dot | Dot | Hollow |
| | Input | Output | Gain | Output | Dot Gain |
| Color | Value | Value | (increase) | Value | (increase) |
| Cyan | 6% | 18% | 12% | 8% | 2% |
| Magenta | 19% | 38% | 19% | 22% | 3% |
| Yellow | 92% | 100% | 8% | 96% | 4% |
| Black | 6% | 18% | 12% | 10% | 4% |

Micro photos were taken of the actual prints. As shown in Table 2, the dye particles are contained and small. The side by side comparison of the hollow dot prints versus the standard prints as shown in Table 3. The standard dots have exploded and bled onto each other causing the colors to blend as one. The hollow dots, on the other hand, retained their individual dot characteristics and the color stays the same.

Thus, specific embodiments and applications of the device and methods have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A device that prints an image by transferring a plurality of dots from a source to a target, each of the plurality of dots having a smaller cross-section on the object than on the source.

2. The device of claim 1, wherein the plurality of dots each have a concave silhouette.

3. The device of claim 1, wherein the plurality of dots are ring-shaped prior to transfer.

4. The device of claim 1, wherein the source comprises a transfer paper.

5. The device of claim 1, wherein the source comprises an ink jet printer.

6. The device of claim 1, wherein the source comprises an electrostatic printer.

7. The device of claim 1, wherein the source comprises an offset press.

8. The device of claim 1, wherein the source comprises a rotogravure press.

9. The device of claim 1, wherein the target comprises a fabric.

10. The device of claim 1, wherein the target comprises a clothing fabric.

11. The device of claim 1, wherein the target comprises a wall paper fabric.

12. The device of claim 1, wherein the target comprises a carpet.

13. The device of claim 1, wherein the target comprises a paper.

14. The device of claim 1, wherein the target comprises plastic.

15. The device of claim 1, wherein the target comprises powder coated metal.

16. The device of claim 1, wherein the plurality of dots are transferred in a gaseous form.

17. The device of claim 1, wherein at least some of the plurality of dots are colored.

18. The device of claim 1, wherein four different ones of the plurality of dots have a different color from one another.

19. A device that prints an image by transferring a plurality of dots from a source to a target, each of the plurality of dots having a first concavity.

20. The device of claim 19 wherein the plurality of dots each have a second concavity opposite the first concavity.

21. A method of printing an image on a target, comprising:
a. creating a dot representation of the image;
b. producing physical dots corresponding to the dot representation, wherein at least some of the physical dots; and
c. transferring the physical dots to the target.

22. The method of claim 21, wherein the step of creating the dot representation comprises creating the dot representation in a digital format.

23. The method of claim 21, wherein the step of producing the physical dots comprises producing the physical dots to have a concavity.

24. The method of claim 21, wherein the step of producing the physical dots comprises producing the physical dots to have opposing concavities.

25. The method of claim 21, wherein the step of transferring the physical dots to the target comprises supplying sufficient heat to vaporize the physical dots.

26. The method of claim 21, wherein the step of transferring the physical dots to the target comprises transferring the physical dots to a moving fabric.
